(19) United States
(12) Patent Application Publication
(10) Pub. No.: US 2017/0199640 A1
(43) Pub. Date: Jul. 13, 2017

(54) ELECTRONIC DEVICE AND USER INTERFACE CHANGING METHOD

(71) Applicant: Chiun Mai Communication Systems, Inc., New Taipei (TW)

(72) Inventors: HOW-WEN CHIEN, New Taipei (TW); SUNG-JAY CHANG, New Taipei (TW)

(21) Appl. No.: 15/181,442

(22) Filed: Jun. 14, 2016

(30) Foreign Application Priority Data
Jan. 7, 2016 (CN) 201610007559.6

(51) Int. Cl. G06F 3/0484; G06F 3/0481; G06K 9/00; G06F 3/041

(52) U.S. Cl. CPC G06F 3/0484; G06F 3/0414; G06F 3/0481; G06K 9/00013; G06K 9/00087

(57) ABSTRACT

An electronic device has a plurality of user interfaces. The electronic device is configured to display different application programs in different interfaces. The electronic device includes a storage module, a biometric identification module, a determining module and a user interface changing module. The storage module stores biometric identification data and a relationship between the at least one biometric identification data and the different user interfaces. The biometric identification module obtains a biometric identification data on a preset area of the electronic device. The determining module determines whether the obtained biometric identification data is consistent with a stored biometric identification data in the storage module. The interface changing module changes the user interface of the electronic device according to the obtained biometric identification data and the relationship. The present disclosure also provides a user interface changing method.

### CROSS-REFERENCE TO RELATED APPLICATIONS

This application claims priority to Chinese Patent Application No. 201610007559.6, filed on Jan. 7, 2016, the contents of which are incorporated by reference herein.

### FIELD

The subject matter herein generally relates to an electronic device, especially relates to a user interface changing method.

### BACKGROUND

People have unique fingerprints. Thus, it is safe to unlocked an electronic device by a fingerprint. When the electronic device is unlocked, the electronic device display same application programs. Sometimes, for example, a user unlocks the electronic device and gives it to a child to use, the user tends to the electronic device to only display the application program associated with children study and children games. Thus, the application program is displayed unfriendly.

### BRIEF DESCRIPTION OF THE DRAWINGS

Implementations of the present technology will now be described, by way of example only, with reference to the attached figures.

FIG. 1 is a schematic view of an electronic device in different user interfaces.

FIG. 2 is a block diagram of the electronic device according to a first embodiment.

FIG. 3 is a block diagram of the electronic device according to a second embodiment.

FIG. 4 is a block diagram of the electronic device according to a third embodiment.

FIG. 5 is a block diagram of the electronic device according to a forth embodiment.

FIG. 6 is a flowchart of a user interface changing method according to a first embodiment.

FIG. 7 is a flowchart of a user interface changing method according to a second embodiment.

FIG. 8 is a flowchart of a user interface changing method according to a third embodiment.

FIG. 9 is a flowchart of a user interface changing method according to a forth embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

A definition that applies throughout this disclosure will now be presented.

The term “comprising” means “including, but not necessarily limited to”; it specifically indicates open-ended inclusion or membership in a so-described combination, group, series, and the like.

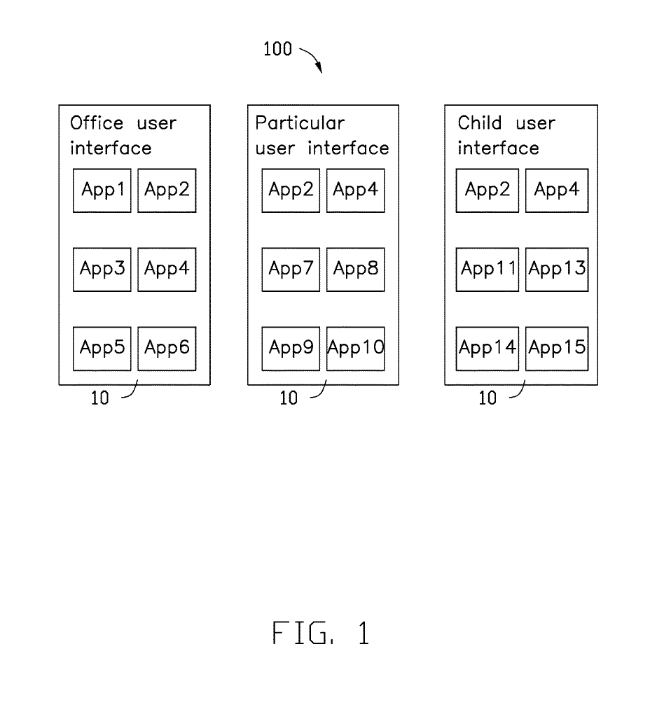

FIG. 1 illustrates an electronic device 100. The electronic device 100 can display different user interfaces in response to different user's operations. In different user interfaces, the electronic device 100 displays different application programs on a displayer 10 of the electronic device 100. The electronic device 100 can be a smart phone, a tablet or a wearable device. In an embodiment, the electronic device 100 has an office user interface, a particular user interface and a child user interface. In the office user interface, the displayer 10 only displays a number of application programs associated with work, for example, an email application program or an office word processing application program. In the particular user interface, the displayer 10 only displays a number of particular application programs associated with user's favorites, for example, a video playing application program. In the child user interface, the displayer 10 only displays a number of application programs associated with children, for example, a children game application program or a children study application program. In the different user interfaces, the displayer 10 can display a number of common application programs, for example, a taking photo application program.

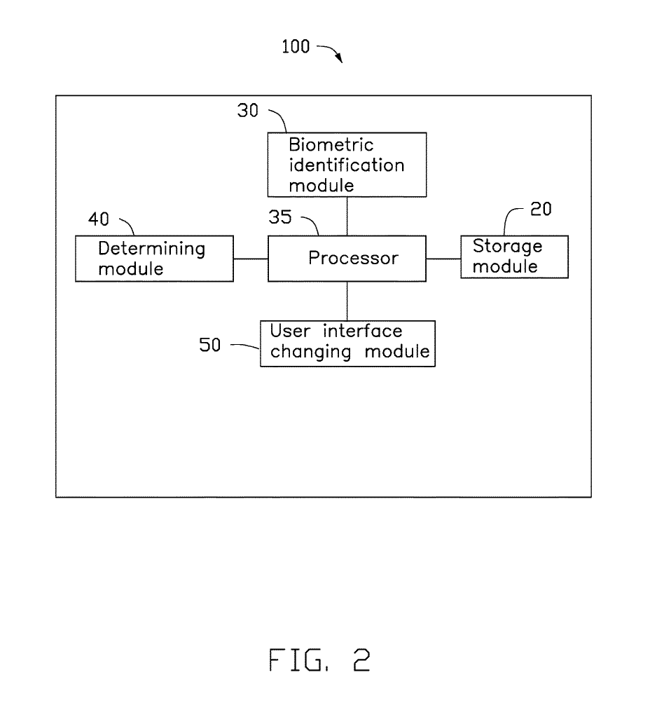

FIG. 2 illustrates electronic device 100, according to a first embodiment, includes a storage module 20, a biometric identification module 30, a determining module 40, a user interface changing module 50 and a processor 35. The processor 35 electrically connects to the storage module 20, the biometric identification module 30, the determining module 40, the user interface changing module 50.

The storage module 20 is configured to store at least one biometric identification data, for example, a thumb fingerprint, a index finger fingerprint, a little finger fingerprint or a palm palmprint. The storage module 20 is further configured to store a relationship between the at least one biometric identification data and the plurality of different user interfaces. The biometric identification module 30 is configured to obtain a biometric identification data on a preset area of the electronic device 100. The determining module 40 is configured to determine whether the obtained biometric identification data is consistent with a stored biometric identification data to obtain a determined result. The user interface changing module 50 changes the user interface of the electronic device 100 according to the obtained biometric identification data, the determined result and the relationship.

For example, the relationship indicates that a user's thumb fingerprint, a user's index finger fingerprint, a user's little finger fingerprint are respectively corresponding to the office user interface, the particular user interface and the child user interface. When the user puts his thumb on the preset area of the electronic device 100, the biometric identification module 30 obtains the user's thumb fingerprint. The determining module 40 determines if the obtained user's thumb fingerprint is consistent with the stored user's thumb fingerprint. The user interface changing module 50 makes the electronic device 100 display the office user interface. The displayer 10 displays the application program associated with work. Similarly, when the user puts his index finger on the preset area of the electronic device 100, the user interface changing module 50 makes the electronic device 100 display the particular user interface. The displayer 10 displays the particular application programs associated with the user's favors. When the user puts his little finger on the preset area of the electronic device 100, the user interface changing module 50 makes the electronic device 100 display the child user interface. The displayer 10 displays the application programs associated with children.

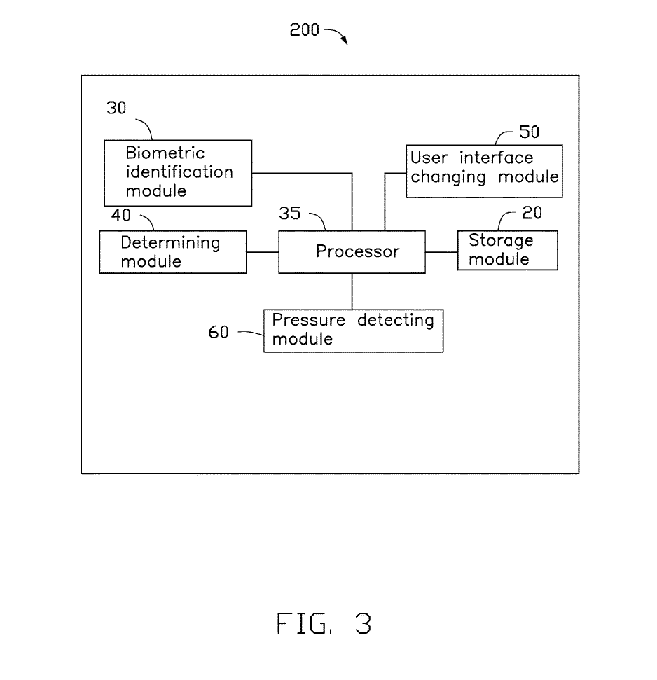

FIG. 3 illustrates the electronic device 200 according to a second embodiment. The electronic device 200 further includes a pressure detecting module 60 electronically connected to the processor 35. The pressure detecting module 60 is configured to detect a pressure of the obtained biometric identification data on the preset area. The relationship further includes a correspondence between the plurality of different user interfaces and at least one pressure of the at least one biometric identification data. The user interface changing module 50 is configured to change the user interface of the electronic device 200 according to the obtained biometric identification data, the pressure of the obtained biometric identification data and the relationship.

For example, the relationship indicates that when the pressure of the biometric identification data is greater than a preset pressure, the electronic device 200 displays corresponding user interface. When the biometric identification data appears on the preset area of the electronic device 200, the biometric identification module 30 obtains the biometric identification data. The determining module 40 determines the obtained biometric identification data is consistent with a stored biometric identification data. The pressure detecting module 60 detects that the pressure of the obtained biometric identification data is greater than the preset pressure. The user interface changing module 50 makes the electronic device 200 display the user interface corresponding to the obtained biometric identification data. In an embodiment, the relationship indicates that when the pressure of a user's thumb data is greater than 1 Pa, the electronic device 200 displays the office user interface. When the user puts his thumb on the preset area and the pressure is greater than 1 Pa, the user interface changing module 50 makes the electronic device 200 display the office user interface. When the user puts his thumb on the preset area, but the pressure is less than 1 Pa, the electronic device 200 remains the present user interface.

In another embodiment, the relationship further includes a correspondence between the plurality of different user interfaces and the at least one pressure of the at least one biometric identification data in different pressure ranges. When the pressure of at least one biometric identification data is within different preset pressure ranges, the electronic device 200 displays different user interfaces. When the biometric identification data appears on the preset area of the electronic device 200, the biometric identification module 30 obtains the biometric identification data. The determining module 40 determines the obtained biometric identification data is consistent with a stored biometric identification data. The pressure detecting module 60 detects the pressure of the obtained biometric identification data is within a preset pressure range. The user interface changing module 50 makes the electronic device 200 display a user interface corresponding to the obtained biometric identification data and the preset pressure range. In an embodiment, the relationship indicates that when the pressure of a user's thumb data is within 1 Pa to 2 Pa, the electronic device 200 displays the office user interface, and when the pressure of a user's thumb data is within 2 Pa to 3 Pa, the electronic device 200 displays the child user interface. When the user puts his thumb on the preset area and the pressure is within 1 Pa to 2 Pa, the user interface changing module 50 makes the electronic device 200 display the office user interface. When the user puts his thumb on the preset area and the pressure is within 2 Pa to 3 Pa, the user interface changing module 50 makes the electronic device 200 display the child user interface. When the user puts his thumb on the preset area, but the pressure is beyond 1 Pa to 3 Pa, the electronic device 200 remains the present user interface. In another embodiment, the user puts his index finger on the preset area and the pressure is within 2 Pa to 3 Pa, although the pressure value meets the preset pressure range, the biometric identification data is not the user's thumb fingerprint, the user interface changing module 50 remains the present user interface.

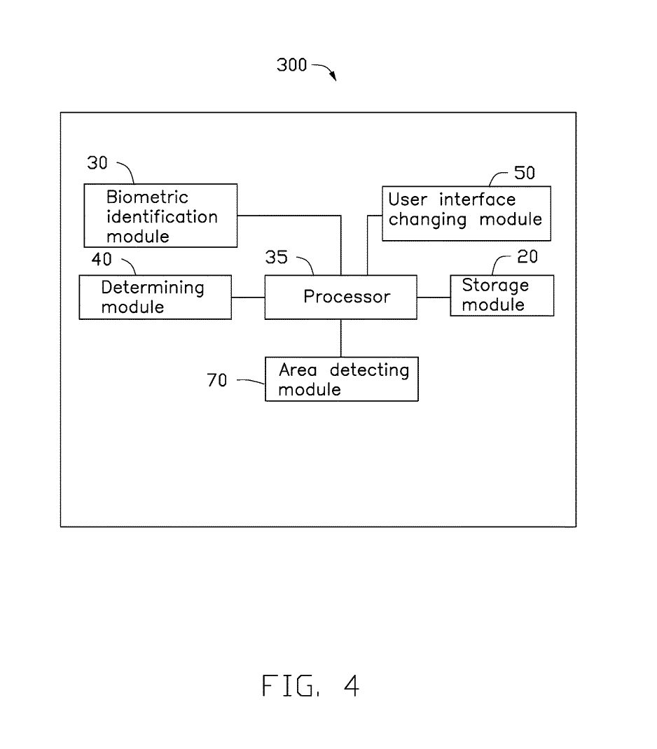

FIG. 4 illustrates the electronic device 300 according to a third embodiment. The electronic device 300 further includes an area detecting module 70 electronically connected to the processor 35. The area detecting module 70 is configured to detect a contact area of the obtained biometric identification data on the preset area. The relationship further comprises a correspondence between the plurality of different user interfaces and at least one contact area of the at least one biometric identification data. The user interface changing module 50 is configured to change electronic device 300 to the user interface corresponding to the obtained biometric identification data and the contact area of the obtained biometric identification data according to the relationship.

For example, the relationship indicates that when the contact area of the biometric identification data is greater than a preset contact area, the electronic device 300 displays corresponding user interface. When the biometric identification data appears on the preset area of the electronic device 300 and the contact area of the biometric identification data is greater than the preset contact area, the user interface changing module 50 makes the electronic device 300 display the user interface corresponding to the obtained biometric identification data. An example is similar to the example in the first embodiment and is omitted here.

In another embodiment, the relationship further includes a correspondence between the plurality of different user interfaces and the at least one contact area of the at least one biometric identification data in different contact area ranges. When the contact area of at least one biometric identification data is within different preset contact area ranges, the electronic device 300 displays different user interfaces. When the biometric identification data appears on the preset area of the electronic device 300, the biometric identification module 30 obtains the biometric identification data. The determining module 40 determines the obtained biometric identification data is consistent with a stored biometric identification data. The area detecting module 70 detects that the contact area of the obtained biometric identification data is within one of the preset contact area range. The user interface changing module 50 makes the electronic device 300 display the user interface corresponding to the obtained biometric identification data and the preset contact area range.

The relationship can indicates that when the contact area of a user's thumb data is within 2 mm²-4 mm², the electronic device 300 displays the office user interface, and when the contact area of a user's thumb data is within 4 mm²-8 mm², the electronic device 300 displays the particular user interface. In at least one embodiment, when the user puts his thumb on the preset area and the contact area is within 2 mm²-4 mm², the user interface changing module 50 makes the electronic device 300 display the office user interface. When the contact area further increases to 4 mm²-8 mm², the user interface changing module 50 changes the electronic device 300 from the office user interface to the particular user interface. In another embodiment, before the his thumb removes from the preset area, the electronic device 300 remains the present user interface, and when the his thumb removes from the preset area, the user interface changing module 50 makes the electronic device 300 display the office user interface corresponding to the contact area of the thumb. If the contact area of the thumb is within 2 mm²-4 mm² before the his thumb removes from the preset area, when the his thumb removes from the preset area, the user interface changing module 50 makes the electronic device 300 display the office user interface. If the contact area of the thumb is within 4 mm²-8 mm² before the his thumb removes from the preset area, when the his thumb removes from the preset area, the user interface changing module 50 makes the electronic device 300 display the particular user interface. In another embodiment, the user puts his index finger on the preset area and the contact area is within 2 mm²-4 mm², although the contact area value meets the preset contact area range, the biometric identification data is not the user's thumb fingerprint, the user interface changing module 50 remains the present user interface.

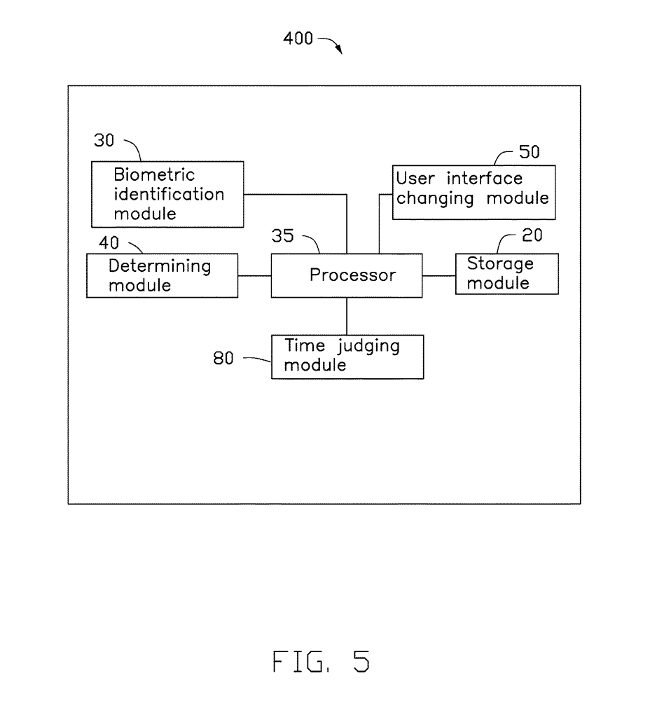

FIG. 5 illustrates the electronic device 400 according to a forth embodiment. The electronic device 400 further includes a time judging module 80 electronically connected to the processor 35. The time judging module 80 is configured to detect a duration of the obtained biometric identification data on the preset area. The relationship further includes a correspondence between the plurality of different user interfaces and the at least one duration of the at least one biometric identification data. The user interface changing module 50 is configured to change electronic device 400 to the user interface corresponding to the obtained biometric identification data and the duration of the obtained biometric identification data according to the relationship.

For example, the relationship indicates that when the duration of the biometric identification data is longer than a preset duration, the electronic device 400 displays corresponding user interface. When the biometric identification data appears on the preset area of the electronic device 400 and the duration of the biometric identification data is longer than the preset duration, the user interface changing module 50 makes the electronic device 400 display corresponding user interface. An example is similar to the example in the first embodiment and is omitted here.

In another embodiment, the relationship further includes a correspondence between the plurality of different user interfaces and the at least one duration of the at least one biometric identification data in different duration ranges. When the duration of at least one biometric identification data is within different preset duration ranges, the electronic device 400 displays different user interfaces. When the biometric identification data appears on the preset area of the electronic device 400, the biometric identification module 30 obtains the biometric identification data. The determining module 40 determines the obtained biometric identification data is consistent with a stored biometric identification data. The time judging module 80 detects that the duration of the obtained biometric identification data is within a preset duration range. The user interface changing module 50 makes the electronic device 400 display the user interface corresponding to the obtained biometric identification data and the preset duration range.

The relationship can indicates that when the duration of a user's thumb data is within three seconds to five seconds, the electronic device 400 displays the office user interface, and when the duration of a user's thumb data is within five seconds to ten seconds, the electronic device 400 displays the particular user interface. In at least one embodiment, when the user puts his thumb on the preset area and the duration is within three seconds to five seconds, the user interface changing module 50 makes the electronic device 400 display the office user interface. When the duration further increases to five seconds to ten seconds, the user interface changing module 50 changes the electronic device 400 from the office user interface to the particular user interface. In another embodiment, before the his thumb removes from the preset area, the electronic device 400 remains the present user interface, and when the his thumb removes from the preset area, the user interface changing module 50 makes the electronic device 400 display the office user interface corresponding to the duration of the thumb. If the duration of the thumb is within three seconds to five seconds, but his thumb remains on the preset area, the electronic device 400 remains present user interface. Then the duration of the thumb increases to five seconds to ten seconds and his thumb removes from the preset area, the user interface changing module 50 makes the electronic device 400 display the particular user interface. In another embodiment, the user puts his index finger on the preset area and the duration is within five seconds to ten seconds, although the duration value meets the preset duration range, the biometric identification data is not the user's thumb fingerprint, the user interface changing module 50 remains the present user interface.

In another embodiment, the relationship further includes a correspondence between the plurality of different user interfaces and at least one password. When the obtained biometric identification data is not consistent with the stored biometric identification data, the electronic device 400 can be changed to a user interface corresponding to a password through inputting the password.

The preset area can be an area of the electronic device 400 outside the displayer 10. The biometric identification module 30 is outside the area of the displayer 10. In another embodiment, the preset area can be an area of the displayer 10. The biometric identification module 30 is positioned in the area of the displayer 10. When the electronic device 400 is locked, the biometric identification module 30 obtains a biometric identification data on the preset area of the electronic device 400.

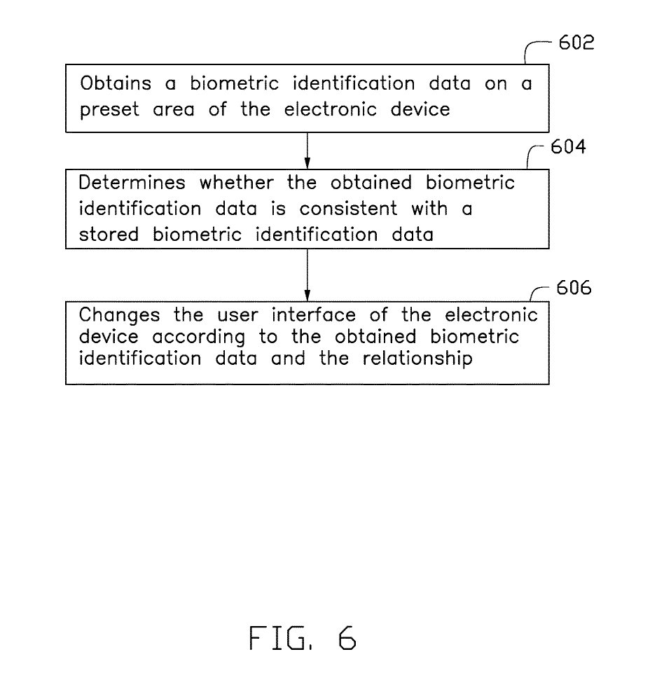

FIG. 6 illustrates a user interface changing method according to a first embodiment. The method is employed to an electronic device 100 having a number of user interfaces. The electronic device 100 can display different user interfaces in response to different user's operations to display different application programs on the displayer 10 of the electronic device 100. The electronic device 100 stores at least one biometric identification data and a relationship between the at least one biometric identification data and the plurality of different user interfaces. The illustrated order of blocks in FIG. 6 is illustrative only and the order of the blocks can change according to the present disclosure. Additional blocks can be added or fewer blocks may be utilized, without departing from this disclosure. The example method can begin at block 602.

At block 602, the biometric identification module 30 obtains a biometric identification data on a preset area of the electronic device 100.

At block 604, the determining module 40 determines whether the obtained biometric identification data is consistent with a stored biometric identification data.

At block 606, the user interface changing module 50 changes the user interface of the electronic device 100 according to the obtained biometric identification data and the relationship.

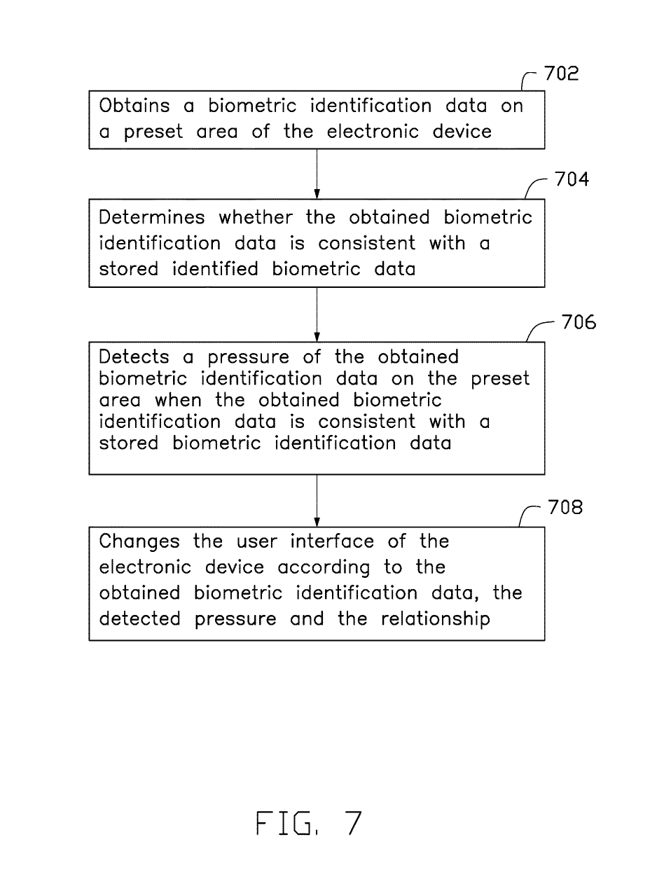

FIG. 7 illustrates a user interface changing method according to a second embodiment. The electronic device 200 stores at least one biometric identification data and a relationship between the at least one biometric identification data, at least one pressure of the at least one biometric identification data and the plurality of different user interfaces. The illustrated order of blocks in FIG. 7 is illustrative only and the order of the blocks can change according to the present disclosure. Additional blocks can be added or fewer blocks may be utilized, without departing from this disclosure. The example method can begin at block 702.

At block 702, the biometric identification module 30 obtains a biometric identification data on a preset area of the electronic device 200.

At block 704, the determining module 40 determines whether the obtained biometric identification data is consistent with a stored biometric identification data.

At block 706, the pressure detecting module 60 detects a pressure of the obtained biometric identification data on the preset area when the obtained biometric identification data is consistent with a stored biometric identification data.

At block 708, the user interface changing module 50 changes the user interface of the electronic device 200 according to the obtained biometric identification data, the detected pressure and the relationship.

In an embodiment, the relationship indicates that when the pressure of the biometric identification data is greater than a preset pressure, the electronic device 200 displays the user interface consistent with the biometric identification data. In another embodiment, the relationship indicates that when the pressure of at least one biometric identification data is within different preset pressure ranges, the electronic device 200 displays different user interfaces consistent with the biometric identification data.

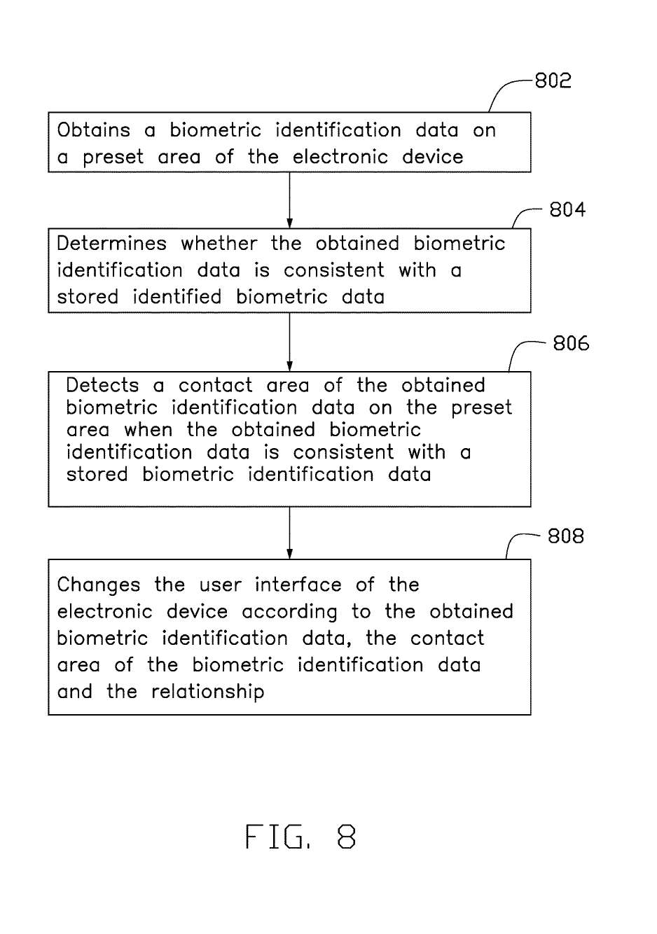

FIG. 8 illustrates a user interface changing method according to a third embodiment. The electronic device 300 stores at least one biometric identification data and a relationship between the biometric identification data, a contact area of the biometric identification data and the user interface. The illustrated order of blocks in FIG. 8 is illustrative only and the order of the blocks can change according to the present disclosure. Additional blocks can be added or fewer blocks may be utilized, without departing from this disclosure. The example method can begin at block 802.

At block 802, the biometric identification module 30 obtains a biometric identification data on a preset area of the electronic device 300.

At block 804, the determining module 40 determines whether the obtained biometric identification data is consistent with a stored biometric identification data.

At block 806, the area detecting module 70 detects a contact area of the obtained biometric identification data on the preset area when the obtained biometric identification data is consistent with a stored biometric identification data.

At block 808, the user interface changing module 50 changes the user interface of the electronic device 300 according to the obtained biometric identification data, the contact area of the biometric identification data and the relationship.

In an embodiment, the relationship indicates that when the contact area of the biometric identification data is greater than a preset contact area, the electronic device 300 displays the user interface consistent with the biometric identification data. In another embodiment, the relationship indicates that when the contact area of at least one biometric identification data is within different preset contact area ranges, the electronic device 300 displays different user interfaces consistent with the biometric identification data.

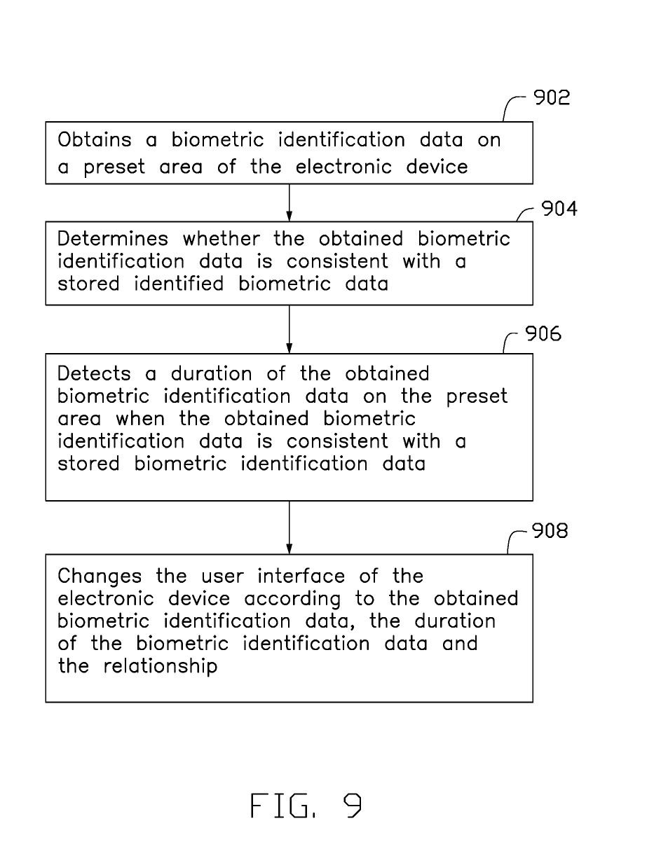

FIG. 9 illustrates a user interface changing method according to a forth embodiment. The electronic device 400 stores at least one biometric identification data and a relationship between the biometric identification data, a duration of the biometric identification data and the user interface. The illustrated order of blocks in FIG. 9 is illustrative only and the order of the blocks can change according to the present disclosure. Additional blocks can be added or fewer blocks may be utilized, without departing from this disclosure. The example method can begin at block 902.

At block 902, the biometric identification module 30 obtains a biometric identification data on a preset area of the electronic device 400.

At block 904, the determining module 40 determines whether the obtained biometric identification data is consistent with a stored biometric identification data.

At block 906, the time judging module 80 detects a duration of the obtained biometric identification data on the preset area when the obtained biometric identification data is consistent with a stored biometric identification data.

At block 908, the user interface changing module 50 changes the user interface of the electronic device 400 according to the obtained biometric identification data, the duration of the biometric identification data and the relationship.

In an embodiment, the relationship indicates that when the duration of the biometric identification data is longer than a preset duration, the electronic device 400 displays the user interface consistent with the biometric identification data. In another embodiment, the relationship indicates that when the duration of at least one biometric identification data is within different preset duration ranges, the electronic device 400 displays different user interfaces consistent with the biometric identification data.

The embodiments shown and described above are only examples. Even though numerous dataistics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims.

What is claimed is:

1. An electronic device having a plurality of user interfaces, the electronic device comprising:
a displayer configured to display different application programs corresponding to one of a plurality of different user interfaces;
a storage module configured to store at least one biometric identification data and a relationship between the at least one biometric identification data and the plurality of different user interfaces;
a biometric identification module configured to obtain a biometric identification data on a preset area of the electronic device;
a determining module configured to determine whether the obtained biometric identification data is consistent with a stored biometric identification data in the storage module to obtain a determined result; and
a user interface changing module configured to change the user interface of the electronic device according to the obtained biometric identification data, the determined result and the relationship.

2. The electronic device as claimed in claim 1, wherein the biometric identification data is a fingerprint.

3. The electronic device as claimed in claim 1, further comprising:
a pressure detecting module configured to detect a pressure of the obtained biometric identification data on the preset area;
wherein the relationship further comprises a correspondence between the plurality of different user interfaces and a pressure of the at least one biometric identification data, the user interface changing module is configured to change the user interface of the electronic device according to the obtained biometric identification data, the pressure of the obtained biometric identification data and the relationship.

4. The electronic device as claimed in claim 3, wherein when the detected pressure of the obtained biometric identification data on the preset area is greater than a preset pressure, the user interface changing module changes the electronic device to a user interface corresponding to the obtained biometric identification data and the detected pressure of the obtained biometric identification data.

5. The electronic device as claimed in claim 3, wherein the relationship further comprises a correspondence between the plurality of different user interfaces and the pressure of the at least one biometric identification data in different pressure ranges, when the detected pressure of the obtained biometric identification data on the preset area is within a preset pressure range, the user interface changing module changes the electronic device to a user interface corresponding to the obtained biometric identification data and the preset pressure range.

6. The electronic device as claimed in claim 1, further comprising:
an area detecting module configured to detect a contact area of the obtained biometric identification data on the preset area;
wherein the relationship further comprises a correspondence between the plurality of different user interfaces and a contact area of the at least one biometric identification data, the user interface changing module is configured to change the user interface of the electronic device according to the obtained biometric identification data, the contact area of the obtained biometric identification data and the relationship.

7. The electronic device as claimed in claim 6, wherein the relationship further comprises a correspondence between the plurality of different user interfaces and the contact area of the at least one biometric identification data in different contact area ranges, when the detected contact area of the obtained biometric identification data on the preset area is within a preset contact area range, the user interface changing module changes the electronic device to a user interface corresponding to the obtained biometric identification data and the preset contact area range.

8. The electronic device as claimed in claim 1, further comprising:
a time judging module configured to detect a duration of the obtained biometric identification data on the preset area;
wherein the relationship further comprises a correspondence between the plurality of different user interfaces and a duration of the at least one biometric identification data, the user interface changing module is configured to change the user interface of the electronic device according to the obtained biometric identification data, the duration of the obtained biometric identification data and the relationship.

9. The electronic device as claimed in claim 8, wherein the relationship further comprises a correspondence between the plurality of different user interfaces and the duration of the at least one biometric identification data in different duration ranges, when the detected duration of the obtained biometric identification data on the preset area is within a preset duration range, the user interface changing module changes the electronic device to a user interface corresponding to the obtained biometric identification data and the preset duration range.

10. The electronic device as claimed in claim 1, wherein the preset area is an area of the electronic device outside the displayer.

11. The electronic device as claimed in claim 1, wherein the preset area is an area of the displayer.

12. The electronic device as claimed in claim 1, wherein the biometric identification module obtains the obtained biometric identification data on the preset area of the electronic device when the electronic device is locked.

13. A user interface changing method to change an electronic device to different user interfaces, the method comprising:
obtaining a biometric identification data on a preset area of the electronic device;
determining whether the obtained biometric identification data is consistent with one of at least one stored biometric identification data in the electronic device; and
changing the user interface of the electronic device according to the obtained biometric identification data and a relationship between the at least one stored biometric identification data and the different user interfaces.

14. A user interface changing method to change an electronic device to different user interfaces, the method comprising:
obtaining a biometric identification data on a preset area of the electronic device;
determining whether the obtained biometric identification data is consistent with one of at least one stored biometric identification data in the electronic device;
detecting a pressure of the obtained biometric identification data on the preset area when the obtained biometric identification data is consistent with a stored biometric identification data; and
changing the user interface of the electronic device according to the obtained biometric identification data, the detected pressure and a relationship between the obtained biometric identification data, the pressure of the obtained biometric identification data and the different user interfaces.

15. The method as claimed in claim 14, wherein when the detected pressure of the obtained biometric identification data on the preset area is greater than a preset pressure, the electronic device is changed to a user interface consistent with the obtained biometric identification data and the detected pressure of the obtained biometric identification data.

16. The method as claimed in claim 14, wherein the relationship comprises a correspondence between the plurality of different user interfaces and the pressure of the at least one biometric identification data in different pressure ranges, when the detected pressure of the obtained biometric identification data on the preset area is within a preset pressure range, the electronic device is changed to a user interface consistent with the obtained biometric identification data and the preset pressure range.

17. A user interface changing method to change an electronic device to different user interfaces, the method comprising:
obtaining a biometric identification data on a preset area of the electronic device;
determining whether the obtained biometric identification data is consistent with one of at least one stored biometric identification data in the electronic device;
detecting a contact area of the obtained biometric identification data on the preset area when the obtained biometric identification data is consistent with a stored biometric identification data; and
changing the user interface of the electronic device according to the obtained biometric identification data, the detected contact area and a relationship between the obtained biometric identification data, the contact area of the obtained biometric identification data and the different user interfaces.

18. The method as claimed in claim 17, wherein the relationship further comprises a correspondence between the plurality of different user interfaces and the contact area of the at least one biometric identification data in different contact area ranges, when the detected contact area of the obtained biometric identification data on the preset area is within a preset contact area range, the electronic device is changed to a user interface consistent with the obtained biometric identification data and the preset contact area range.

19. A user interface changing method to change an electronic device to different user interfaces, the method comprising:
obtaining a biometric identification data on a preset area of the electronic device;
determining whether the obtained biometric identification data is consistent with one of at least one stored biometric identification data in the electronic device;
detecting a duration of the obtained biometric identification data on the preset area when the obtained biometric identification data is consistent with a stored biometric identification data; and
changing the user interface of the electronic device according to the obtained biometric identification data, the duration of the obtained biometric identification data and a relationship between the obtained biometric identification data, the duration of the obtained biometric identification data and the different user interfaces.

20. The method as claimed in claim 19, wherein the relationship further comprises a correspondence between the plurality of different user interfaces and the duration of the at least one biometric identification data in different duration ranges, when the detected duration of the obtained biometric identification data on the preset area is within a preset duration range, the electronic device is changed to a user interface consistent with the obtained biometric identification data and the preset duration range.
